(19) United States
(12) Patent Application Publication
(10) Pub. No.: US 2011/0167951 A1
(43) Pub. Date: Jul. 14, 2011

(54) KICKDOWN DEVICE FOR ELECTRONIC PEDAL ASSEMBLY

(75) Inventors: Scott J. Thiel, Sherwood, OR (US); Michael D. Cooper, Tualatin, OR (US)

(73) Assignee: WILLIAMS CONTROLS, INC., Portland, OR (US)

(21) Appl. No.: 13/004,797

(22) Filed: Jan. 11, 2011

Related U.S. Application Data
(60) Provisional application No. 61/293,962, filed on Jan. 11, 2010.

(51) Int. Cl. G05G 1/44

(52) U.S. Cl. 74/512

(57) ABSTRACT

Embodiments relate to pedal assemblies, particularly pedal assemblies having a kickdown device that includes one or more deformable tactile domes adapted to uniformly deform or invert on application of sufficient force. This deformation, flattening, or inversion may result in a kickdown effect that may correspond to an engine kickdown. Additionally, the device may be adapted for engagement with a pedal assembly to impart a hysteresis effect as the pedal moves relative to the body.

### CROSS REFERENCE TO RELATED APPLICATIONS

The present application claims priority to U.S. Provisional Patent Application No. 61/293,962 filed Jan. 11, 2010, entitled “KICKDOWN DEVICE FOR ELECTRONIC PEDAL ASSEMBLY,” the disclosure of which is hereby incorporated by reference in its entirety.

### TECHNICAL FIELD

Embodiments of the present invention relate generally to the field of vehicle pedals, and more particularly to a throttle pedal assembly having a kickdown feature.

### BACKGROUND

Many mechanical systems have a variety of shortcomings. For example, components in a mechanical system that are mechanically connected and moveable relative to each other are subject to friction. As such, these components wear out over time. Also, fasteners connecting two or more components in a mechanical system often loosen over time, typically as a result of being subjected to extended periods of vibration in the system. Non-mechanical controls for vehicles overcome these shortcomings and thus are becoming increasingly common. Such systems generally include an electronic opening and closing of the engine throttle based on position of a throttle pedal that may be operated by an operator or driver. However, these systems typically lack a mechanical connection such as a cable between the engine and the throttle pedal. Consequently, a driver or operator may lose a tactile feel or feedback from the engine.

One aspect of the loss of tactile feel is what is known as the hysteresis, which may be the effect of pedal resistance the operator feels as the pedal is depressed. Another aspect of the loss of tactile feel is the sensation of the point at which the engine kicks down to a lower gear, such as when the vehicle is going up a hill or attempting to pass. In some instances, kickdown devices are used to generate tactile feedback for the operator.

Existing kickdown devices are generally based on axial moving plungers that, when actuated, work in one of a few ways. One kickdown mechanism works by displacing a ferrous metal plate relative to a fixed magnet. The force input to actuate the plunger generally must overcome the magnetic attraction force between the fixed magnet and the ferrous metal plate. This style of device is generally housed in the pedal module lever arm or the pedal fixed body or bracket. Another mechanism works by displacing rolling elements such as ball bearings or pins from formed recesses in a direction perpendicular to the axis of the plunger. The rolling elements are usually rolled against controlled metal edges in the form of spring clips or leaf springs that provide the correct location and magnitude of the calculated peak kickdown force. A third technique is disclosed in U.S. patent application Ser. No. 11/174,008.

### BRIEF DESCRIPTION OF THE DRAWINGS

Embodiments of the present invention will be readily understood by the following detailed description in conjunction with the accompanying drawings. Embodiments of the invention are illustrated by way of example and not by way of limitation in the figures of the accompanying drawings.

FIG. 1 illustrates a pedal assembly and a tactile dome kickdown device in accordance with various embodiments;

FIG. 2 includes two panels illustrating cross-sectional views of a pedal assembly and tactile dome kickdown device in accordance with various embodiments; FIG. 2A illustrates a closed-throttle position and FIG. 2B illustrates a kickdown initiation position, in accordance with various embodiments;

FIG. 3 illustrates a perspective view of a tactile dome kickdown device in accordance with various embodiments;

FIG. 4 illustrates an exploded view of a tactile dome kickdown device in accordance with various embodiments;

FIG. 5 illustrates a cross-sectional view of a pedal assembly and a tactile dome kickdown device in a kickdown initiation position, in accordance with various embodiments;

FIG. 6 illustrates a pedal force plot, in accordance with various embodiments.

### DETAILED DESCRIPTION OF EMBODIMENTS

In the following detailed description, reference is made to the accompanying drawings which form a part hereof, and in which are shown by way of illustration embodiments in which the disclosure may be practiced. It is to be understood that other embodiments may be utilized and structural or logical changes may be made without departing from the scope of the present disclosure. Therefore, the following detailed description is not to be taken in a limiting sense, and the scopes of embodiments, in accordance with the present disclosure, are defined by the appended claims and their equivalents.

Various operations may be described as multiple discrete operations in turn, in a manner that may be helpful in understanding embodiments of the present invention; however, the order of description should not be construed to imply that these operations are order-dependent.

The description may use perspective-based descriptions such as up/down, back/front, and top/bottom. Such descriptions are merely used to facilitate the discussion and are not intended to restrict the application of embodiments of the present invention.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “NB” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

Embodiments of the present disclosure may be directed to electronically controlled pedal assemblies having a kickdown feature that is adapted to provide a resistance at a set pedal position to signal the pedal range at which engine/transmission kickdown is likely to occur. In one embodiment, a throttle pedal may include a kickdown feature wherein a determined resistance may be overcome to then allow the pedal to be further depressed, wherein the determined resistance point coincides with engine and/or transmission kickdown. In some embodiments, the pedal assembly may also include a hysteresis component aimed at providing additional variable resistance to the pedal as it is applied and released, combined with a kickdown feature in a simple and efficient design. Further embodiments of the present invention may include a kickdown feature that may be modified, changed, and/or manipulated to increase or decrease both the kickdown position and the amount of kickdown resistance.

In various embodiments, pedal assemblies are provided that have a mechanical kickdown device that may provide an operator a tactile feedback, for instance for when they are entering a full-fueling condition for the vehicle engine, a transmission downshift for an automatic transmission, or an override condition for a vehicle speed limiter. In embodiments, the device may require the operator to overcome a calculated input force at the accelerator pedal pad in order for the pedal to be depressed sufficiently to move the pedal accelerator position sensor into the sensor output zones that may trigger kickdown.

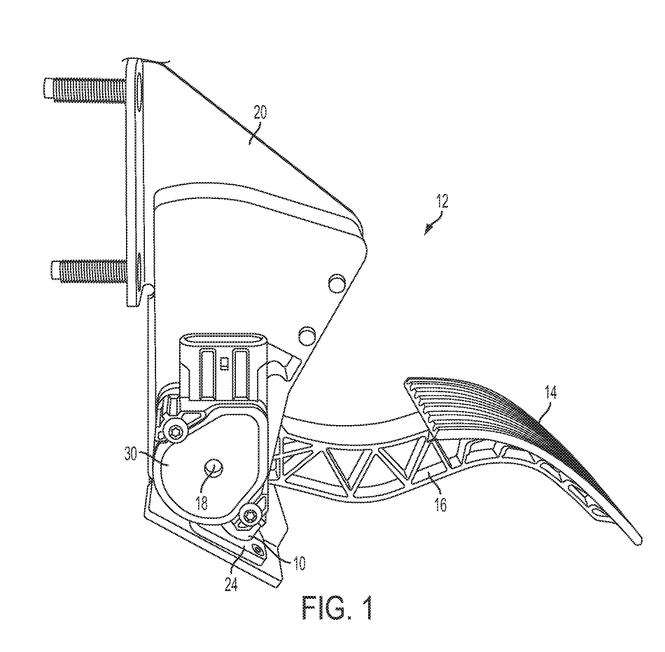

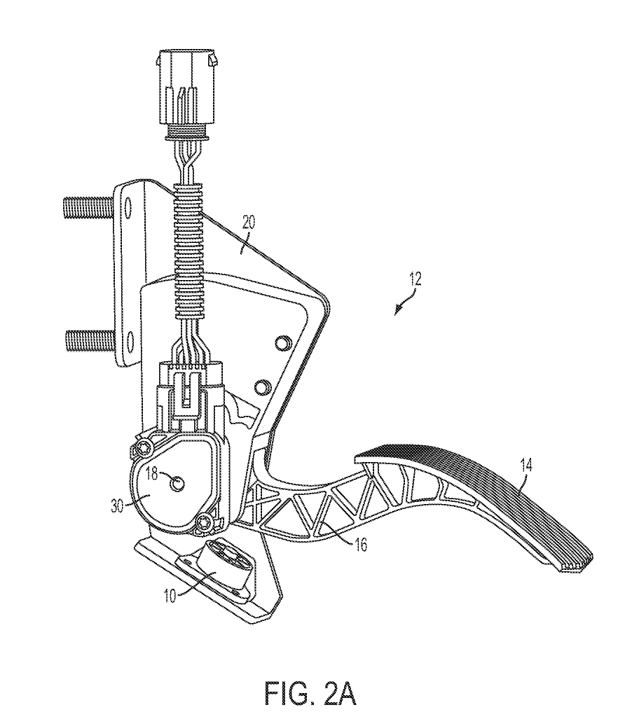

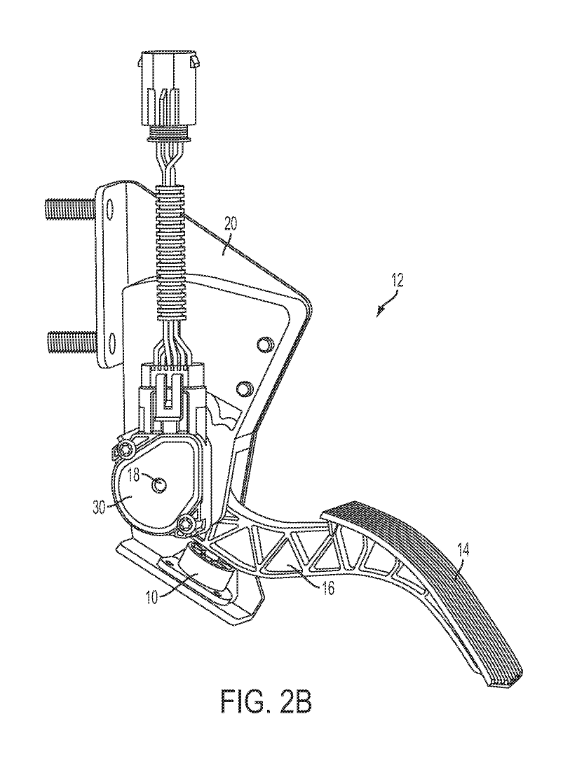

In embodiments, improved kickdown devices are disclosed that overcome many of the shortcomings of these existing kickdown devices. An example of such a kickdown device is shown in use with a pedal assembly in FIG. 1, and cross-sectional views of an exemplary pedal assembly and kickdown device are shown in FIGS. 2A and 2B. Referring to FIG. 2, in various embodiments, the improved kickdown device 10 and pedal assembly 12 may include a pedal pad 14 mounted on a pedal module lever arm 16 that may be rotated about a main pivot point 18 relative to a rigid mounting base, such as pedal module base 20. In embodiments, kickdown device 10 may be mounted to pedal module base 20, which may result in lever arm 16 moving relative to kickdown device 10 in some embodiments. In embodiments, depression of pedal pad 14 by an operator may cause pedal module level arm 16 to rotate about main pivot point 18 and engage with kickdown device 10.

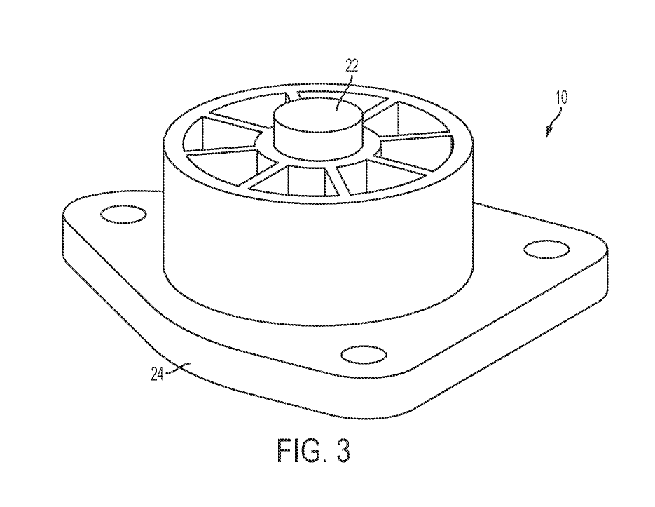

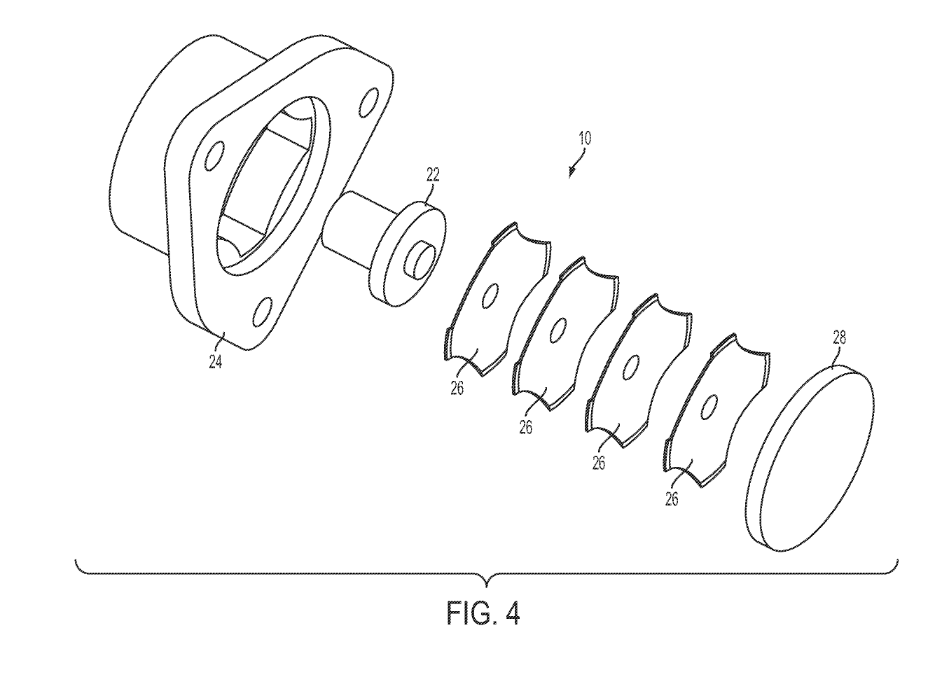

FIG. 3 shows a fully-assembled exemplary kickdown device, and FIG. 4 illustrates an exploded view of the same kickdown device. As shown in FIG. 4, a moveable member 22, for instance a depressible axial plunger, may be mounted in or on the housing 24 of kickdown device 10. When depressed by pedal module lever arm 16, moveable member 22 may compress or uniformly deform one or more tactile domes 26 within housing 24. Compression or deformation of the one or more tactile domes 26 may generate additional resistance to the actuator and, as described in greater detail below, may activate a kickdown feature when a predetermined level of compression (e.g., the calculated peak force) is applied. In some embodiments, the domes may be compressed against a spacer disc 28 within housing 24.

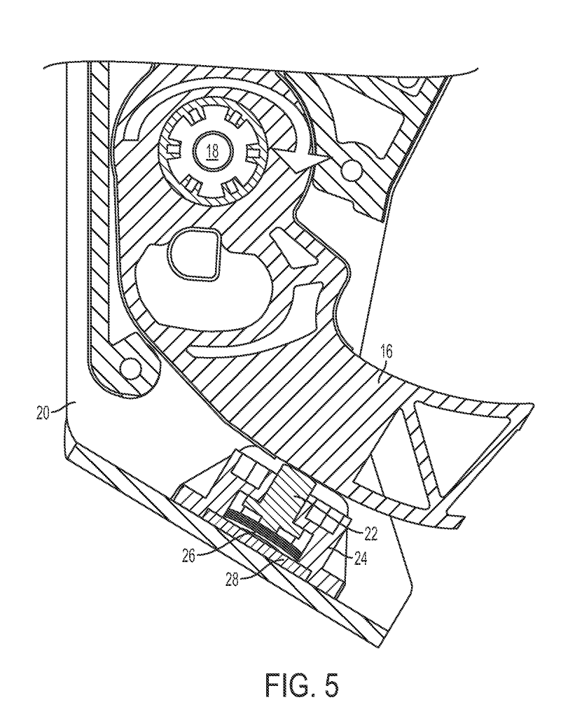

Referring to FIG. 5, once pedal module lever arm 16 contacts moveable member 22 (the kickdown initiation point, according to some embodiments), in some embodiments moveable member 22 may compress or otherwise uniformly deform tactile domes 26 if lever arm 16 continues to rotate further about main pivot point 18 (for instance, in response to continued or increased pressure on pedal pad 14). In some embodiments, as the operator increases the force input at lever arm pedal pad 14, moveable member 22 may compress or uniformly deform tactile domes 26.

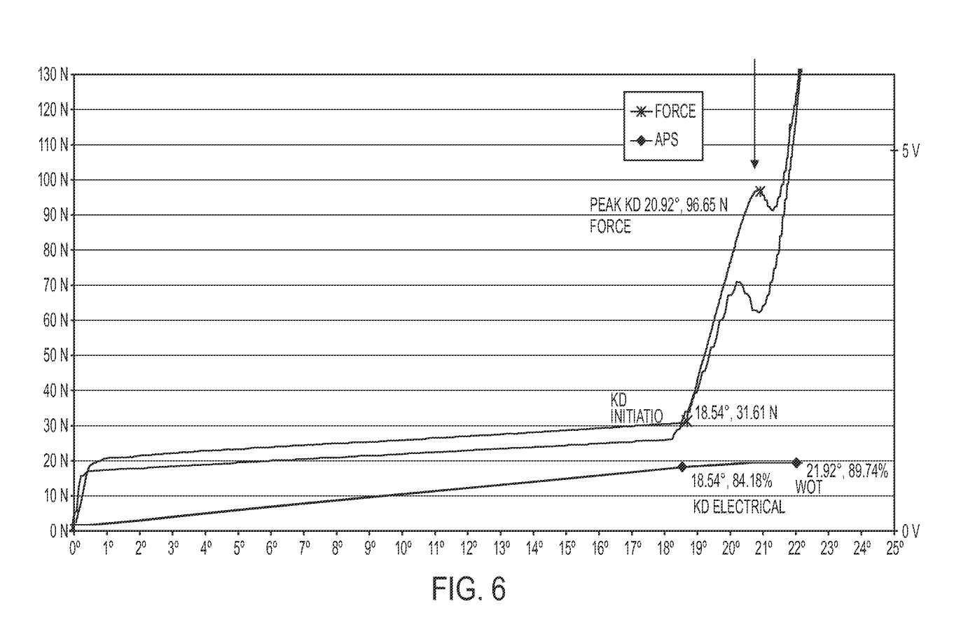

In various embodiments, tactile domes 26 may require a calculated peak force before the spring constant is overcome and the domes uniformly deform or compress maximally. FIG. 6 illustrates the pedal force required to depress an exemplary pedal assembly 12 with an exemplary kickdown device 10. In use, when the peak kickdown force has been achieved (for instance, where indicated by the arrow), moveable member 22 may compress tactile domes 26 to a calculated distance, for instance about 2 mm, about 3 mm, about 4 mm, or about 5 mm. In embodiments, as the peak force is applied to pedal pad 14 (for instance, where the inflection point is indicated by the arrow), tactile domes 26 may begin to uniformly deform or invert. With the application of sufficient force, tactile domes 26 may be rapidly deformed or inverted from a convex shape to form a flattening or concavity, thereby reducing the resistance force and resulting in the kickdown effect. As a result, pedal module lever arm 16 may rotate an additional angular distance, and consequently accelerator position sensor 30 may be rotated into the kickdown or full-fueling sensor output range, in some embodiments. This kickdown point may be the point where the engine/transmission kickdown can occur, and overcoming of the increase in resistance may provide tactile feedback to the operator that signals engine kickdown.

The present kickdown device includes many advantages over the current state of the art kickdown devices. For instance, depending on the desired kickdown force, the disclosed kickdown device may reduce the number of total components used, thus reducing the cost to manufacture, maintain, or repair the device or simplifying assembly. Additionally, in some embodiments, the peak force required to activate the kickdown feature may be easily adjusted by altering the number of tactile domes installed in the device, the material the tactile domes are made out of, or the thickness of the tactile domes.

Another advantage of the improved kickdown device, as compared to existing devices, is that the device may be mounted to ferrous metal rigid mounting bases without the concern of obstructing the magnetic field present in magnetic-based devices. Further, the simplicity of the design means that the wear and tear of numerous components moving relative to one another may be minimized. Additionally, noise levels produced by the device may be low compared to magnetic-based devices.

In some embodiments, as pedal module lever arm 16 moves against moveable member 22, the initial compression resistance of tactile domes 26 may provide additional resistance against the movement of pedal module lever arm 16. Additionally, in some embodiments, a spring or other biasing member (not shown) may be coupled to pedal module lever arm 16 to provide measured resistance and a gradual opposing force to the pedal movement. The biasing member may include, but is not limited to, a coil spring, a leaf spring, a compression spring, a tension spring, elastomers, or any other known biasing material. The biasing member may be arranged to bias pedal module lever arm 16 to a throttle-closed position, and in some embodiments may act on pedal module lever arm 16 to return throttle pedal pad 14 to an idle position after the resistance force is relieved.

In various embodiments, pedal assembly 12 may be configured to have replaceable or interchangeable parts, for example, interchangeable pedal pads 14 and lever arms 16 while using common other parts of the arrangement. This may reduce manufacturing and assembly costs. Furthermore, pedal assembly 12 may be configured to be useable with interchangeable tactile dome kickdown devices 10, and the stiffness or resistance of the tactile dome kickdown device may be adjusted by the use of interchangeable tactile domes 26 with different stiffnesses or thicknesses, or by use of two or more stacked tactile domes 26 as shown in FIG. 4. For instance, increasing the number of tactile domes 26 used in a kickdown device may, in some embodiments, increase the pedal pressure required to activate the kickdown feature. Some embodiments do not have a movable member 22, but rather employ a pedal module lever arm 16 that presses directly on tactile domes 26, for instance via a raised knob or bump on the surface of the pedal module lever arm 16 that may be adapted to engage the tactile domes 26.

Embodiments of the present disclosure may be used with any type of pedal assembly, including, but not limited to suspended pedals, floor mounted pedals, remote pedal assemblies and the like. Embodiments may be configured to have a hysteresis effect in conjunction with, or separate from, a kickdown feature. Embodiments also may be used with a pedal having a contact surface that is part of a housing or that is separate from a housing. Embodiments also may be configured with an arcuate housing or a straight housing. Embodiments also may be configured wherein the kickdown feature is configured with the housing, or configured separate from the housing.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of the present disclosure. Those with skill in the art will readily appreciate that embodiments in accordance with the present disclosure may be implemented in a very wide variety of ways. This application is intended to cover any adaptations or variations of the embodiments discussed herein. Therefore, it is manifestly intended that embodiments in accordance with the present disclosure be limited only by the claims and the equivalents thereof.

1. A kickdown pedal comprising:
a mounting brace;
a kickdown device coupled to the mounting brace, wherein the kickdown device comprises one or more compressible tactile domes; and
a pedal assembly coupled to the mounting brace and comprising a pedal pad coupled to a lever arm, wherein the lever arm is configured to rotate around a pivot point relative to the mounting brace and compress the kickdown device;
wherein the kickdown pedal is configured to activate a kickdown feature when a predetermined level of compression is applied to the kickdown device.

2. The kickdown pedal of claim 1, wherein the one ore more tactile domes are configured to deform when the predetermined level of compression is applied to the kickdown device.

3. The kickdown pedal of claim 1, wherein the pedal further comprises a pedal accelerator position sensor, and wherein the accelerator position sensor is configured to activate the kickdown feature when the predetermined level of compression is applied to the kickdown device.

4. The kickdown pedal of claim 1, wherein the kickdown feature comprises a full-fueling condition for a vehicle engine, a transmission downshift for an automatic transmission, or an override condition for a vehicle speed limiter.

5. The kickdown pedal of claim 1, wherein the kickdown device is configured to provide tactile feedback to a user when the pedal assembly engages the kickdown device.

6. The kickdown pedal of claim 1, wherein the kickdown device is configured to provide tactile feedback to a user when the predetermined level of compression is applied to the kickdown device.

7. The kickdown pedal of claim 2, further comprising a housing adapted to house the kickdown device.

8. The kickdown pedal of claim 7, further comprising an axial plunger disposed within the housing and adapted to be depressed by the lever arm and compress the kickdown device when the pedal pad is depressed.

9. The kickdown pedal of claim 7, further comprising a spacer disposed beneath the one or more tactile domes.

10. The kickdown pedal of claim 9, wherein the one or more tactile domes are configured to compress against the spacer when the kickdown device is compressed.

11. The kickdown pedal of claim 2, where the one or more tactile domes are configured to deform a calculated distance when the predetermined level of compression is applied to the kickdown device.

12. The kickdown pedal of claim 11, wherein the calculated distance is from about 2 mm to about 5 mm.

13. The kickdown pedal of claim 2, wherein the one or more tactile domes comprise a convex apex, and wherein the convex apex is adapted to deform to form a flattening or concavity when the predetermined level of compression is applied to the kickdown device.

14. The kickdown pedal of claim 1, wherein the predetermined level of compression may be increased by increasing the number of tactile domes or by replacing the one or more tactile domes with one or more tactile domes having a greater thickness or stiffness.

15. The kickdown pedal of claim 1, wherein the predetermined level of compression may be decreased by decreasing the number of tactile domes or by replacing the one or more tactile domes with one or more tactile domes having a lesser thickness or stiffness.

16. The kickdown pedal of claim 1, wherein the mounting brace comprises a ferrous metal.

17. The kickdown pedal of claim 1, further comprising a biasing member configured to resist depression of the pedal pad.

18. The kickdown pedal of claim 17, wherein the biasing member comprises a coil spring, a leaf spring, a compression spring, a tension spring, or an elastomer.

19. The kickdown pedal of claim 1, wherein the lever arm comprises a projection configured to engage the kickdown device.

20. The kickdown pedal of claim 1, wherein the kickdown pedal is a suspended pedal, a floor mounted pedal, or a remote pedal assembly.
